(19) United States
(12) Patent Application Publication
(10) Pub. No.: US 2026/0281129 A1
(43) Pub. Date: Sep. 17, 2026

(54) ATTACK-RESILIENT FEDERATED MACHINE LEARNING AGAINST ADVERSARIAL THREATS IN UTILITY SYSTEMS

(71) Applicant: Alliance for Energy Innovation, LLC, Golden, CO (US)

(72) Inventors: Ethan TUCKER, Golden, CO (US); Vivek Kumar SINGH, Parker, CO (US); Rakib HOSSAIN, Reno, NV (US)

(21) Appl. No.: 19/530,587

(22) Filed: Feb. 5, 2026

Related U.S. Application Data
(60) Provisional application No. 63/757,392, filed on Feb. 12, 2025.

(51) Int. Cl. H04L 9/40; G06N 3/048; G06N 3/084; H04L 41/16

(52) U.S. Cl. CPC H04L 63/1416; G06N 3/048; G06N 3/084; H04L 41/16

(57) ABSTRACT

Techniques for identifying an adversarial threat to a utility system using a federated machine learning system are presented. The utility system may cover multiple local geographic regions, each including a respective plurality of local utility system data sources. The federated machine learning system includes a global neural network portion and a respective local neural network portion for each of the respective plurality of local utility system data sources. The techniques may include: providing respective local data from a respective local plurality of utility system data sources to a respective local neural network portion; passing, from respective local neural network portions to a global database, respective pluralities of local activation outputs; drawing representative local activation outputs from the set of pluralities of local activation outputs; passing a representation of the set of pluralities of local activation outputs to the global neural network portion, from which an adversarial threat prediction is obtained.

### CROSS-REFERENCE TO RELATED APPLICATIONS

This application claims the benefit of U.S. Provisional Application No. 63/757,392 filed Feb. 12, 2025, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

This disclosure relates generally to security in networked systems.

### BACKGROUND

Supervisory Control and Data Acquisition (SCADA) allows for control of industrial systems, such as the power grid, through networked data communications between computers placed at edge clients. SCADA is highly effective for operating complex systems but introduces many exploitable attack vectors.

Classical approaches to cybersecurity on SCADA systems include classical intrusion detection systems such as Snort and Suricata. However, classical intrusion detection systems generally only work for known threat patterns represented in their registers, so newer approaches focus on artificial intelligence controllers and artificial intelligence anomaly detectors. Nevertheless, centralized machine learning techniques that monitor power systems for cyber-attacks are subject to single points of failure.

Techniques such as disclosed in Mukherjee, et al., Enhancing Cyber Resilience of Networked Microgrids Using Vertical Federated Reinforcement Learning, 2023 IEEE Power & Energy Society General Meeting (PESGM) (pp. 1-5) (hereinafter, “Mukherjee”) attempt to address the single-point-of-failure issue and use vertical federated reinforcement learning to restore successfully attacked grids to normal operative conditions. However, Mukherjee is only able to mitigate those attacks that were used to train the model initially and is therefore unable to adapt to novel intrusions and zero-day exploits. Further, Mukherjee does not address attacks on the machine learning intrusion detection system itself.

Other techniques, such as disclosed in Ceballos, et al., SplitNN-Driven Vertical Partitioning, arXiv:2008.04137 (hereinafter, “Ceballos”), attempt to mitigate the common issue of clients failing to communicate with the global model (called drop-outs) during vertical Split-NN model training. Nevertheless, Ceballos' techniques may be fully subverted by intelligent data substitution in a communication channel of the intrusion detection system itself.

### SUMMARY

According to various embodiments, a method of identifying an adversarial threat to a utility system using a federated machine learning system is presented. The utility system covers a plurality of local geographic regions, where each local geographic region includes a respective plurality of local utility system data sources. The federated machine learning system includes: a global neural network portion, and a respective local neural network portion for each of the respective plurality of local utility system data sources. The method includes: providing respective local data including respective local utility system data from a respective local plurality of utility system data sources to a respective local neural network portion, from which a respective plurality of local activation outputs are obtained; passing, from respective local neural network portions and to a global database, respective pluralities of local activation outputs, whereby the global database stores a set of pluralities of local activation outputs; drawing representative local activation outputs from the set of pluralities of local activation outputs, from which a representation of the set of pluralities of local activation outputs is obtained; passing the representation of the set of pluralities of local activation outputs to the global neural network portion, from which an adversarial threat prediction is obtained; and outputting an indication of the adversarial threat prediction.

Various optional features of the above method embodiments include the following. The method may include ameliorating an adversarial threat specified by the indication of the adversarial threat prediction. The adversarial threat may include an attack using at least one of: a false data injection attack, a replay attack, or a denial-of-service attack. The drawing representative local activation outputs from the set of pluralities of local activation outputs may include selecting, randomly, a slice of local activation outputs from the set of pluralities of local activation outputs. The method may include, prior to the selecting, component-wise ordering local activation outputs in the set of pluralities of local activation outputs, from which a component-wise ordered set of local activation outputs is obtained, where the selecting includes selecting the slice of activation outputs from the component-wise ordered set of local activation outputs.

The method may include training the federated machine learning system by repeatedly performing actions including: passing respective local training data including respective training local utility system data to a respective local neural network portion, from which a respective training plurality of local activation outputs are obtained; passing, from respective local neural network portions and to the global database, respective training pluralities of local activation outputs, whereby the global database stores a training set of pluralities of local activation outputs; drawing training representative local activation outputs from the training set of pluralities of local activation outputs, from which a training representation of the set of pluralities of local activation outputs is obtained; passing the training representation of the set of pluralities of local activation outputs to the global neural network portion, from which a respective loss is obtained; and back-propagating the respective loss through the federated machine learning system.

Local utility system data may be correlated between the plurality of local geographic regions. A number of components in the local utility system data may vary among the plurality of local geographic regions. Each plurality of local activation outputs may have a same number of components. The adversarial threat prediction may include at least one of: a presence or absence of an adversarial threat, a location of an adversarial threat, or a classification of an adversarial threat. The utility system may include an energy system, where the energy system covers the plurality of local geographic regions by supplying electricity to each of the plurality of local geographic regions, where a respective plurality of local utility system data sources includes a respective plurality of local energy system data sources, where the federated machine learning system includes a respective local neural network portion for each of the respective plurality of local energy system data sources, and where the providing includes providing respective local data including respective local energy system data from a respective local plurality of energy system data sources to a respective local neural network portion.

The respective local energy system data from the respective local plurality of energy system data sources may include at least one of: grid information, Supervisory Control and Data Acquisition (SCADA) data, phasor measurement units (PMUs), smart meter information, or load forecast information. The adversarial threat may include an attack on at least one of: power grid measurement signals, power grid control signals, or federated machine learning system communication channels. Each respective local plurality of energy system data sources may include at least one cyber system data source and at least one energy system operation data source. The energy system operation data source may include a phasor data source.

According to various embodiments, a non-transitory computer-readable medium is presented. The non-transitory computer-readable medium includes instructions that, when executed by an electronic processor, configure the electronic processor to identify an adversarial threat in a utility system using a federated machine learning system by performing actions as described above in reference to the example method embodiments.

According to various embodiments, a system for identifying an adversarial threat in a utility system using federated machine learning is presented. The system for identifying the adversarial threat includes an electronic processor and a non-transitory computer-readable medium including instructions that, when executed by the electronic processor, configure the electronic processor to perform actions as described above in reference to the example method embodiments.

Combinations, (including multiple dependent combinations) of the above-described elements and those within the specification have been contemplated by the inventors and may be made, except where otherwise indicated or contradictory.

### BRIEF DESCRIPTION OF THE DRAWINGS

Various features of the examples can be more fully appreciated, as the same become better understood with reference to the following detailed description of the examples when considered in connection with the accompanying figures, in which:

FIG. 1 is a schematic diagram of a federated machine learning system for identifying an adversarial threat to an energy system that supplies electricity to a plurality of local geographic regions, according to various embodiments;

FIG. 2 is a flow diagram for a method of training a federated machine learning system to identify an adversarial threat to an energy system that supplies electricity to a plurality of local geographic regions, according to various embodiments;

FIG. 3 is a flow diagram for a method of identifying an adversarial threat to an energy system that supplies electricity to a plurality of local geographic regions using a federated machine learning system, according to various embodiments;

FIG. 4 is a flow diagram for a method of drawing local activation outputs from a set of pluralities of local activation outputs in a federated machine learning system for identifying an adversarial threat to an energy system that supplies electricity to a plurality of local geographic regions, according to various embodiments;

FIG. 5 depicts charts comparing an embodiment to various other techniques in terms of accuracy of adversarial data injection binary classification;

FIG. 6 depicts charts comparing an embodiment to various other techniques in terms of accuracy of adversarial data injection location classification; and

FIG. 7 depicts charts comparing an embodiment to various other techniques in terms of accuracy of adversarial data injection attack type classification.

### REFERENCE NUMBERS

100 . . . vertical federated machine learning system
101 . . . power system layer
111, 112, 113 . . . local geographic regions
121, 122, 123 . . . local neural network portions
130 . . . wide-area network
150 . . . control center
151 . . . global database
152 . . . stochastic representor
153 . . . selector
154 . . . sorting algorithm
155 . . . random number generator
156 . . . global neural network portion
157 . . . cyber-physical events classification
158 . . . Energy Management System (EMS) applications
200 . . . method of training a federated machine learning system
202 . . . passing local training data
204 . . . passing training pluralities
206 . . . drawing training outputs
208 . . . passing training representations
210 . . . back-propagating a loss
212 . . . assessing training process
214 . . . using a trained system
300 . . . method of identifying an adversarial threat
302 . . . providing local data to local neural network portion
304 . . . passing local activation outputs to global database
306 . . . drawing representative local activation outputs
308 . . . passing representative local activation outputs to global neural network portion
310 . . . outputting an indication of an adversarial threat prediction
312 . . . ameliorating a predicted adversarial threat
400 . . . method of drawing local activation outputs
402 . . . obtaining local activation outputs
404 . . . component-wise ordering of local activation outputs
406 . . . selecting a slice of local activation outputs DESCRIPTION OF THE EXAMPLES

Reference will now be made in detail to example implementations, illustrated in the accompanying drawings. Wherever convenient, the same reference numbers will be used throughout the drawings to refer to the same or like parts. In the following description, reference is made to the accompanying drawings that form a part thereof, and in which is shown by way of illustration specific exemplary examples in which the invention may be practiced. These examples are described in sufficient detail to enable those skilled in the art to practice the invention and it is to be understood that other examples may be utilized and that changes may be made without departing from the scope of the invention. The following description is, therefore, merely exemplary.

Some embodiments are advantageous for protecting large-scale utility systems, such as power grids, which are generally vulnerable to communication failure and data tampering. Some embodiments improve the resiliency of vertical federated machine learning threat detection systems by making them self-healing against various adversarial tasks. “Vertical” may refer to systems in which different geographic regions have respective feature spaces and threat detection system portions. Some embodiments protect against data manipulation attacks against the communications of the vertical federated machine learning threat detection system itself. Some embodiments are effective against zero-day exploits and novel attacks that were not included in the training dataset.

Some embodiments identify adversarial threats on a utility system, such as an energy system, by utilizing a vertical federated machine learning system that includes a global neural network portion together with local neural network portions for each of a plurality of local energy systems. The architecture of such embodiments, together with a strategy for drawing local activation outputs from the outputs of the local neural network portions, e.g., by randomly selecting a slice of activation outputs from a component-wise ordering of the local activation outputs, prevents attackers from using intelligent data substitution in the communication channels of the threat detection system to subvert the threat detection system itself. For example, in contrast to systems such as Mukherjee, some embodiments are resistant to attacks against communication channels between the local neural network portions and the global neural network portions.

Some embodiments draw representative local activation outputs from among the local activation outputs of the local neural network portions of a vertical federated machine learning threat detection system, which prevents an attacker from designing an effective intelligent adversarial attack. For example, known pooling functions have exploitable mathematical properties that can be used to corrupt the inputs to threat detection system machine learning algorithms. By contrast, some embodiments utilize a constantly shifting randomization on the strategy for drawing the representative local activation outputs, which prevents adversaries from being able to exploit the representation because they cannot know the strategy for drawing it during the attack design stage.

These and other features and advantages are shown and described herein in reference to the accompanying figures.

Note that example embodiments are shown and described herein in reference to energy systems, by way of non-limiting example. However, embodiments are not limited to protecting energy systems. In general, embodiments may be used to protect any large-scale industrial control system, e.g., that covers a plurality of geographic regions. Such an industrial control system may be for a natural gas distribution network, a water supply network, or a different utility network, again by way of non-limiting examples. Thus, reference herein to energy systems is intended to be by way of illustration, rather than limitation.

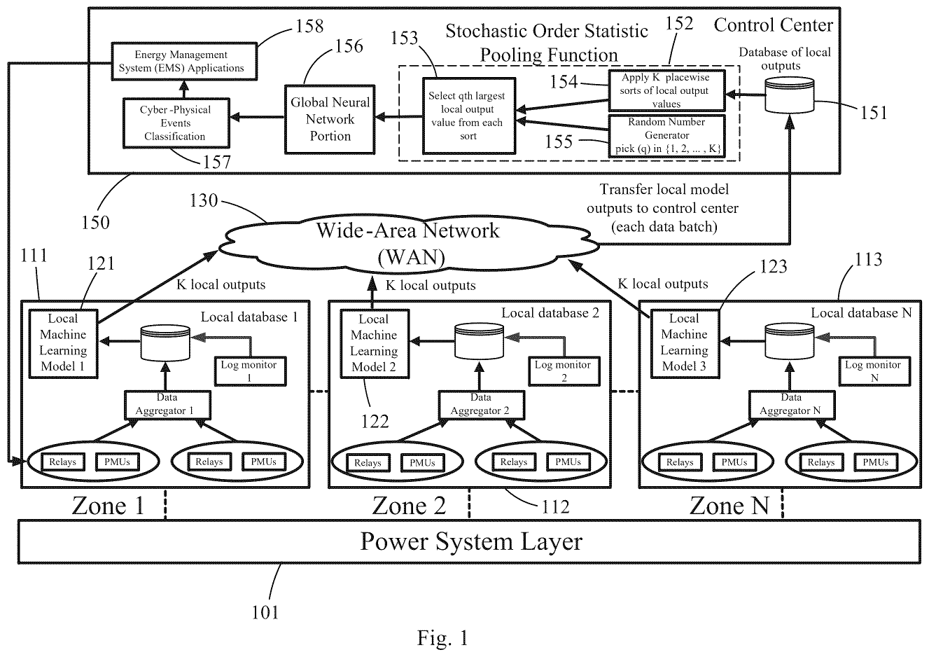

FIG. 1 is a schematic diagram of a federated machine learning system 100 for identifying an adversarial threat to an energy system that supplies electricity to a plurality of local geographic regions, according to various embodiments.

As shown in FIG. 1, the energy system includes a power system layer 101, which supplies electricity to a plurality of local geographic regions 111, 112, 113, denoted Zone 1, Zone 2, . . . , Zone N in FIG. 1. The energy system also includes a control center 150. The control center 150 may include Energy Management System (EMS) applications 158, which communicate with and control the portions of the energy system disposed in the various local geographic regions 111, 112, 113 through direct communication lines and/or through a wide-area network 130, such as the internet. The energy system may include both SCADA and EMS systems working together to monitor and control the overall energy system. In general, an energy system can include a Distributed Energy Resource Management System (DERMS), a Demand Management System (DMS), and/or a load outage management system. For example, the SCADA and EMS systems may collectively monitor, control, and collect data from data sources (e.g., sensors) throughout the energy system.

Each local geographic region 111, 112, 113 may be of any of a variety of sizes, and may correspond to a section of the electrical grid as defined by its geographical area and electrical characteristics. The size of a local geographic region (e.g., 111, 112, 113) may be a function of factors such as transmission line capacity, substation locations, and/or load distribution. For example, a local geographic region (e.g., 111, 112, 113) may be a portion of the energy system that is protected by a particular protective relay. Each local geographic region (e.g., 111, 112, 113) has an associated plurality of local data sources. According to various embodiments, the various local geographic regions 111, 112, 113 may have differing numbers of local data sources and thus generate differing numbers of local data. For a given local geographic region (e.g., 111, 112, 113), the local data sources may generally include local energy system data sources and/or local cyber system data sources.

In general, local energy system data sources may provide data characterizing the portion of the power system layer 101 present in the respective local geographic region (e.g., 111, 112, 113). According to some embodiments, the local energy system data sources may include, by way of non-limiting example, one or more phasor measurement units (PMU), which provide voltage data, frequency data, active power data, reactive power data, angle data, and/or grid parameter data. According to some embodiments, the local energy system data sources may include, by way of non-limiting example, one or more relays, which may provide current, voltage, frequency, active and reactive power values, status of relay and breaker, system and access logs, control parameters, security alarms, and/or configuration parameters.

The local energy system data sources may include, by way of non-limiting examples, one or more phasor data concatenators (PDC), which may aggregate and/or provide grid data such as phasor data (voltage and current), active and reactive power values, and status of circuit breakers and relays. Local energy system data sources also include environmental data, such as solar irradiance, wind speed, and/or temperature, which affect renewable energy production.

Each local geographic region (e.g., 111, 112, 113) may include a respective local data aggregator, shown in FIG. 1 as Data Aggregator 1 for local geographic region 111, Data Aggregator 2 for local geographic region 112, . . . , Data Aggregator N for local geographic region 113. Each local data aggregator may combine (e.g., concatenate) data from the local energy system data sources in its local geographic region (e.g., 111, 112, 113). Note that, in general, embodiments may utilize local data obtained from aggregators, obtained from sensors, or obtained from a combination of aggregators and sensors.

In general, local cyber system data sources may provide data characterizing the cyber system (in contrast to the energy system) for the respective local geographic region (e.g., 111, 112, 113). According to some embodiments, the local cyber system data sources may include, by way of non-limiting example, one or more computer system logs, which may provide records of the computer system (e.g., usage of the computer system, such as user login/logout times and identities, etc.), information on network layout, connectivity, and/or status of communication links. According to some embodiments, the local cyber system data sources may include, by way of non-limiting example, one or more network system logs, which may provide records of the network (e.g., bandwidth used, packet latency, packet identities, network problems, port activity, etc.).

Note that in general, at least the local energy system data from among the local energy system data sources may be correlated between the local geographic regions 111, 112, 113, e.g., due to interactions within the power system layer 101. For example, a power surge within a portion of the power system layer 101 may propagate throughout the entire power system layer 101.

Each local geographic region (e.g., 111, 112, 113) has an associated local database, shown in FIG. 1 as Local Database 1 for local geographic region 111, Local Database 2 for local geographic region 112, . . . , Local Database N for local geographic region 113. Each local database may aggregate and store data from its respective local data sources, including local energy system data sources and/or local cyber system data sources.

Note that embodiments are not limited to the energy system architecture shown and described herein in reference to FIG. 1. More generally, embodiments may protect any large-scale industrial control system, such as any utility system. Thus, more generally, each local geographic region (e.g., 111, 112, 113) may have various individual data sources such as sensors, actuators, programmable logic controllers, motors, valves, switches, etc. Further, each local geographic region (e.g., 111, 112, 113) may have one or more associated controllers, generally located within a respective local geographic region, which acquires data from the aforementioned individual data sources and provides it to a respective local neural network portion. Thus, a local geographic region (e.g., 111, 112, 113) may or may not include a respective local database.

In general, the architecture of the vertical federated machine learning system 100 that identifies adversarial threats includes a distributed neural network, which includes both a global neural network portion 156 and a plurality of local neural network portions 121, 122, 123, each for a respective local geographic region 111, 112, 113 and its respective local data sources. Thus, the architecture includes local neural network portions 121, 122, 123 in the substation network, and a global neural network portion 156 deployed at the grid control center 150. The global neural network portion 156 and the plurality of local neural network portions 121, 122, 123 may each include one or more neural network layers. According to various embodiments, the local neural network portions 121, 122, 123 may have input (e.g., first) layers of varying sizes in order to accommodate differing numbers of local data sources among the various local geographic regions 111, 112, 113.

During both training and usage of the federated machine learning system 100 that identifies adversarial threats, the local neural network portions 121, 122, 123 and the global neural network portion 156 operate together. Each local neural network portion 121, 122, 123 receives and inputs respective local data, e.g., retrieving it from its respective local database. Each local neural network portion 121, 122, 123 provides an output corresponding to its input, which it passes, e.g., through the wide-area network 130, to the control center 150, which draws from the outputs an input that is passed to the global neural network portion 156.

In general, an output provided by a local neural network portion 121, 122, 123 may include a plurality of neural network activation values. The activation values from a given local neural network portion 121, 122, 123 may be generated by activation functions of a terminal (e.g., last) layer of the local network portion. Non-limiting example activation functions include Rectified Linear Unit (ReLU) activation functions, sigmoid activation functions, hyperbolic tangent activation functions, and/or Gaussian Error Linear Unit (GELU) activation functions. In general, the activation functions determine which neurons are activated as information passes through the network's layers, providing non-linearity between neurons and transforming input signals into output signals that are passed on to the next layer.

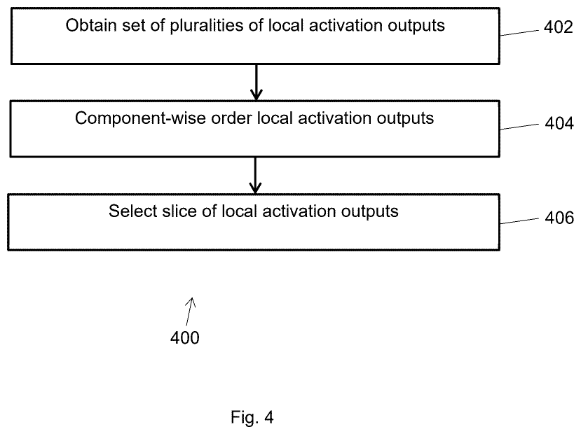

According to some embodiments, the local activation outputs sent from the local neural network portions 121, 122, 123 may be first mapped to the same distribution. For example, a batch normalization process may be implemented. According to some embodiments, a standard normal distribution may be used. The mapping of the outputs to the same distribution helps prevent an attacker from exploiting distributional shift across the local neural network portions 121, 122, 123. Further, the mapping of the outputs to the same distribution may be used to ensure that the local activation outputs have the same dimensionality, e.g., to facilitate implementing the method 400 as shown and described herein in reference to FIG. 4.

The control center 150 receives the local activation outputs sent from the local neural network portions 121, 122, 123 and stores them in a global database 151. The global database 151 may be implemented in persistent and/or volatile memory, according to various embodiments. The global database 151 thus stores a set of pluralities of local activation outputs collectively sent from the local neural network portions 121, 122, 123.

A stochastic representor 152 in the control center 150 may process the set of pluralities of local activation outputs as follows. The stochastic representor 152 may include a processor and a memory (e.g., volatile and/or persistent) which operate together to perform the actions described herein. In general, the stochastic representor 152 may draw randomized subsets of outputs from the local neural network portions 121, 122, 123, thereby making it unpredictable to an adversary that wishes to perform data integrity attacks on the local neural network portions 121, 122, 123 and/or their outputs over the wide-area network. A non-limiting example of such a drawing process is described below. For purposes of notation, consider that each of the N local neural network portions 121, 122, 123 provides K activation values. A random number generator 155 may generate a random number Q between 1 and N inclusive. The random number generator 155 may include a true random number generator and/or a pseudorandom number generator. Prior to, subsequent to, or in parallel, a sorting algorithm 154 component-wise sorts the set of pluralities of local activation outputs. A selector 153 in the stochastic representor 152 then selects a slice of local activation outputs, e.g., by selecting, for each of the K activation values, the Q-th largest local activation output from among the N local activation outputs. This results in the slice of local activation outputs being randomly drawn from among typically several, if not all, of the local activation outputs sent from the local neural network portions 121, 122, 123. The slice of local activation outputs thus provides a representation of the set of pluralities of local activation outputs. The operation of the stochastic representor 152 is shown and described herein in detail in reference to FIG. 4.

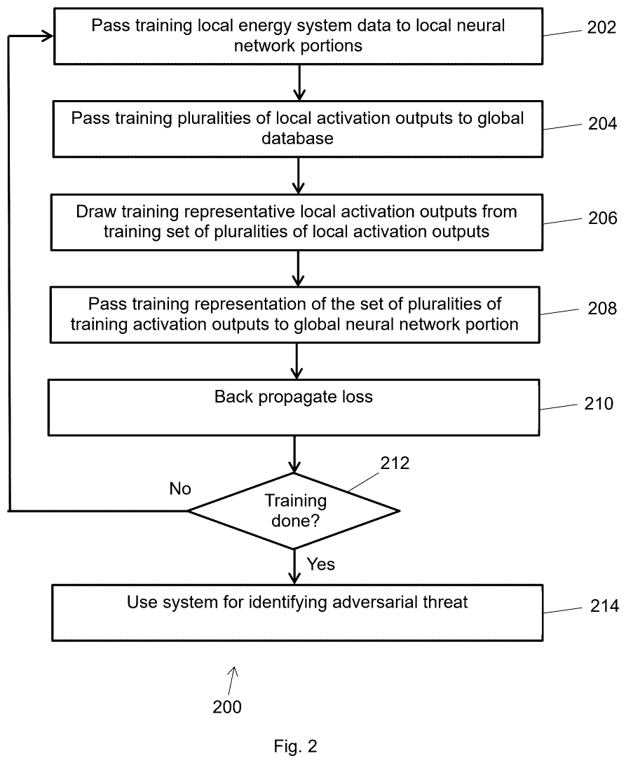

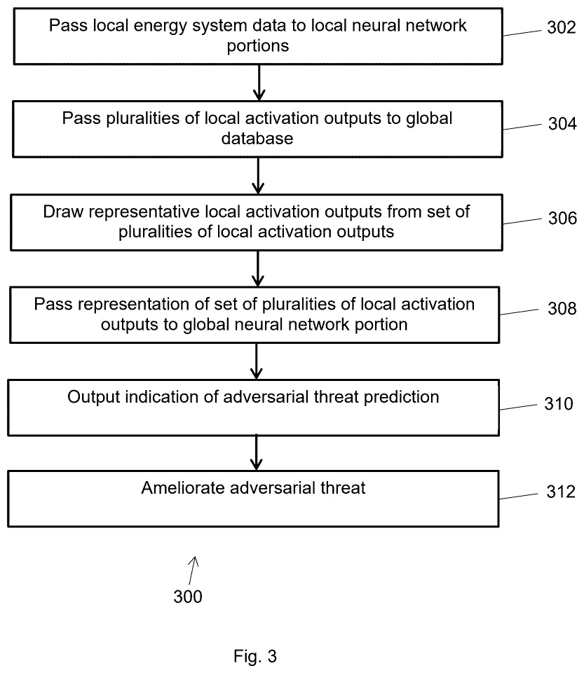

The representation of the set of pluralities of local activation outputs is then passed as an input to the global neural network portion 156. The global neural network portion 156 passes the input through its layer(s) and produces an output, which may represent a prediction (e.g., a probability and/or classification) of an adversarial threat. Any of a variety of adversarial threats may be predicted, including, by way of non-limiting example, a false data injection attack, a replay attack, and/or a denial-of-service attack. The adversarial threat may include an attack on power grid measurement signals, power grid control signals, and/or communication signals of the federated machine learning adversarial threat prediction system itself. By way of non-limiting example, FIG. 1 shows a cyber-physical events classification 157. During training, as shown and described herein in reference to FIG. 2, the threat prediction is compared to a ground truth to obtain a loss, which is back-propagated throughout the entire neural network, including the local neural network portions 121, 122, 123 and the global neural network portion 156, to train the system. During deployment, as shown and described herein in reference to FIG. 3, the threat prediction may be displayed to a user and/or sent to the EMS applications 158, which may mitigate the predicted threat by controlling all or portions of the power system layer 101.

FIG. 2 is a flow diagram for a method 200 of training a federated machine learning system to identify an adversarial threat to an energy system that supplies electricity to a plurality of local geographic regions, according to various embodiments. The method 200 may be implemented to train a federated machine learning system to identify an adversarial threat to an energy system, as shown and described herein in reference to FIG. 1, for example.

At 202, the method 200 includes passing respective local training data to each of a plurality of respective local neural network portions. The actions of 202 may be implemented in whole or in part as shown and described in reference to FIG. 1 with respect to the local geographic regions 111, 112, 113 and their local neural network portions 121, 122, 123. Each local training data may be actual or simulated data. Each local training data may be labeled as representing an adversarial threat or benign. Each local training data may include training local energy system data and/or local cyber system data, according to various embodiments. Inputting each local training data to a corresponding local neural network portion results in the local neural network portion outputting a training plurality of local activation outputs.

At 204, the method 200 includes passing, from local neural network portions to a global database, corresponding training pluralities of local activation outputs. The actions of 204 may be implemented in whole or in part as shown and described in reference to FIG. 1 with respect to the local neural network portions 121, 122, 123, the global neural network portion 156, the global database 151, and the wide-area network 130. The actions of 204 result in the global database storing a training set of pluralities of local activation outputs. Note that due to various factors, e.g., an ongoing denial of service attack, fewer than the total number of neural network portions may pass their local activation outputs to the global database according to 204.

At 206, the method 200 includes drawing training representative local activation outputs from the training set of pluralities of local activation outputs. The actions of 206 may be implemented in whole or in part as shown and described in reference to FIG. 1 with respect to the stochastic representor 152. The actions of 206 result in obtaining a training representation of the set of pluralities of local activation outputs.

At 208, the method 200 includes passing the training representation of the set of pluralities of local activation outputs to the global neural network portion. The actions of 208 may be implemented in whole or in part as shown and described in reference to FIG. 1 with respect to the stochastic representor 152 and the global neural network portion 156. The actions of 208 result in the global neural network portion 156 outputting a training adversarial threat prediction, from which, together with a ground truth label, a respective loss is derived.

At 210, the method 200 includes back-propagating the respective loss through the federated machine learning system. The actions of 210 may be implemented in whole or in part as shown and described in reference to FIG. 1 with respect to the local neural network portions 121, 122, 123 and the global neural network portion 156. The back-propagation may adjust the weights of the overall neural network so that it can accurately predict known and unknown (e.g., zero day) threats.

At 212, the method 200 includes assessing whether the training process is done. The assessment may be based on whether an entire training corpus has been exhausted, e.g., in one or more training epochs, may be based on an assessed prediction accuracy, or both, by way of non-limiting examples. If the training process is not done, then control reverts to 202. If the training process is done, then control passes to 214.

At 214, the method 200 includes using the trained system to predict an adversarial threat. The actions of 214 may be implemented in whole or in part as shown and described in general in reference to FIG. 1. An example deployment of the trained system to predict an adversarial threat is shown and described herein in reference to FIG. 3.

FIG. 3 is a flow diagram for a method 300 of identifying an adversarial threat to an energy system that supplies electricity to a plurality of local geographic regions using a federated machine learning system, according to various embodiments. The method 300 may be implemented by a federated machine learning system to identify an adversarial threat to an energy system, as shown and described herein in reference to FIG. 1, for example.

At 302, the method 300 includes providing respective local data from a respective local plurality of energy system data sources to a respective local neural network portion. The actions of 302 may be implemented in whole or in part as shown and described in reference to FIG. 1 with respect to the local geographic regions 111, 112, 113 and their local neural network portions 121, 122, 123. Each local data may include local energy system data and/or local cyber system data, according to various embodiments. Inputting each local data to a corresponding local neural network portion results in the local neural network portion outputting a plurality of local activation outputs.

At 304, the method 300 includes passing, from local neural network portions and to a global database, respective pluralities of local activation outputs. The actions of 304 may be implemented in whole or in part as shown and described in reference to FIG. 1 with respect to local neural network portions 121, 122, 123, the global neural network portion 156, the global database 151, and the wide-area network 130. The actions of 304 result in the global database storing a set of pluralities of local activation outputs. Note that due to various factors, e.g., an ongoing denial of service attack, fewer than the total number of neural network portions may pass their local activation outputs to the global database according to 304.

At 306, the method 300 includes drawing representative local activation outputs from the set of pluralities of local activation outputs. The actions of 306 may be implemented in whole or in part as shown and described in reference to FIG. 1 with respect to the stochastic representor 152. The actions of 306 result in obtaining a representation of the set of pluralities of local activation outputs.

At 308, the method 300 includes passing the representation of the set of pluralities of local activation outputs to the global neural network portion. The actions of 308 may be implemented in whole or in part as shown and described in reference to FIG. 1 with respect to the stochastic representor 152 and the global neural network portion 156. The actions of 308 result in the global neural network portion outputting an adversarial threat prediction.

At 310, the method 300 includes outputting an indication of the adversarial threat prediction. The actions of 310 may be implemented in whole or in part as shown and described generally in reference to FIG. 1. The outputting may include displaying on a computer monitor, sending over a network, such as a wide-area network, and/or providing to an automated adversarial threat amelioration process, by way of non-limiting examples.

At 312, the method 300 includes ameliorating a predicted adversarial threat. The actions of 312 may be implemented in whole or in part as shown and described in reference to FIG. 1 with respect to the EMS applications 158, by way of non-limiting example. According to some embodiments, the actions of 312 may include restoring the electrical grid to a normal condition, e.g., in terms of various grid parameters such as voltage and/or frequency.

FIG. 4 is a flow diagram for a method 400 of drawing local activation outputs from a set of pluralities of local activation outputs in a federated machine learning system for identifying an adversarial threat to an energy system that supplies electricity to a plurality of local geographic regions, according to various embodiments. The method 400 may be implemented to facilitate a process for drawing representative local activation outputs from a set of pluralities of local activation outputs, e.g., as shown and described herein in reference to FIG. 1 (stochastic representor 152), FIG. 2 (206) and/or FIG. 3 (306).

At 402, the method 400 includes obtaining a set of pluralities of local activation outputs. The method 400 is described presently in reference to FIG. 4 using an illustrative rather than limiting example. This example is presented in reference to N=4 local neural network portions and K=3 activation values. Each vector below represents a respective local neural network portion; therefore, there are four vectors in the example. Each vector includes three activation values; therefore, each vector contains three components in the example. Note that for purposes of explanation, the example is a highly simplified example; an actual embodiment may include more (e.g., far more) local neural network portions and activation values.

$$[ \begin{matrix}0.1 \\ 0.6 \\ 0.5\end{matrix} ] [ \begin{matrix}0.3 \\ 0.1 \\ 0.9\end{matrix} ] [ \begin{matrix}0.9 \\ 0.4 \\ 0.2\end{matrix} ] [ \begin{matrix}0.7 \\ 0.5 \\ 0.8\end{matrix} ]$$

At 404, the method 400 includes component-wise ordering the local activation outputs. Further in reference to the ongoing example, the actions of 404 include ordering the values within each component. The actions of 404 may thus include aggregating the activation values across the local neural network portions, which may produce K=3 sequences, each of size N=4. As shown in the example, the component values are ordered from least to greatest. Thus, the first component is aggregated as the sequence (0.1, 0.3, 0.9, 0.7) and reordered to (0.1, 0.3, 0.7, 0.9) in the ongoing example. (Nevertheless, the ordering may be from least to greatest or greatest to least, according to various embodiments.) The complete reordering of the ongoing example is shown below:

$$[ \begin{matrix}0.1 \\ 0.1 \\ 0.2\end{matrix} ] [ \begin{matrix}0.3 \\ 0.4 \\ 0.5\end{matrix} ] [ \begin{matrix}0.7 \\ 0.5 \\ 0.8\end{matrix} ] [ \begin{matrix}0.9 \\ 0.6 \\ 0.9\end{matrix} ]$$

For the reordering, ties may be broken randomly or using any other technique.

At 406, the method 400 includes selecting a slice of local activation outputs. The actions of 406 includes selecting a random number Q between 1 and N inclusive. In the ongoing example, for purposes of illustration, Q=2. Thus, for the ongoing example, the second sequence is selected as the slice:

$$[ \begin{matrix}0.3 \\ 0.4 \\ 0.5\end{matrix} ]$$

This randomly selected slice may then be passed to the global machine learning model. Note that the selection is not simply random sampling, as the slice represents the component at the same Q-th location from each of the ordered sequences. Note further that the method 400 reduces the dimension of the input space to the global model from N×K to K.

A particular advantage of the method 400 is that the probability that no value in the slice is corrupted by an adversarial attack on the communication channels of the threat detection system converges to one as the number of local geographic regions increases.

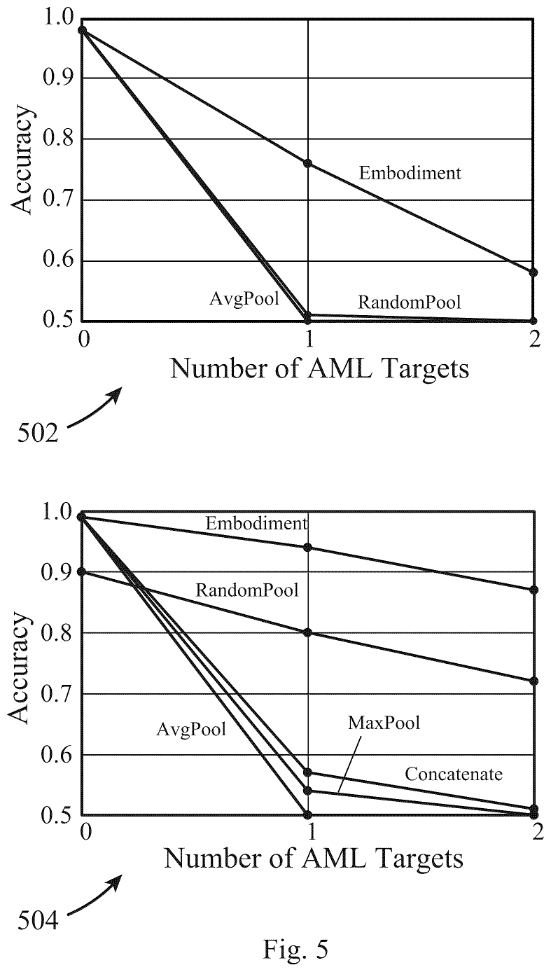

FIG. 5 depicts charts 502, 504 comparing an embodiment to various other techniques in terms of accuracy of adversarial data injection binary classification. The embodiment utilized techniques as shown and described herein in reference to FIGS. 2-4 in a simulated environment similar to that shown and described herein in reference to FIG. 1. The charts 502, 504 depict mean accuracy of classifying whether an adversarial data injection attack has occurred on a vertical federated machine learning system deployed to protect a simulated electrical system. The charts 502, 504 depict mean accuracy as a function of number of local neural networks targeted. Chart 502 represents an electrical system with three local geographic regions (and three respective local neural network portions). Chart 504 represents an electrical system with thirteen local geographic regions (and thirteen respective local neural network portions). Both electrical systems were simulated using standard IEEE 3-bus and 13-bus Power Energy & Society (PES) test feeder systems.

As represented in the charts 502, 504, the embodiment utilized drawing representative local activation outputs by way of the component-wise ordering and random slice selection of the method 400 as shown and described in reference to FIG. 4, for example. The charts 502, 504 compare the embodiment with the following techniques. In RandomPool, values were selected from the set of pluralities of local activation outputs completely randomly within each component, i.e., without respect to whether they represented the same slice in a reordering of the components. In MixedPool, values were selected randomly from the plurality of local outputs as follows. The selected values were either the average from the pluralities of local activation outputs maximum of available values, selected with a certain probability p, or the maximum element selected from the pluralities of local activation outputs average of available values with the complement probability (1−p). In MaxPool, the maximum values from the set of pluralities of local activation outputs within each component were selected. In Concatenate, the entire plurality of local outputs was selected when present. When missing values occurred during Concatenate, they were replaced with zeroes. All local output values are forwarded without discrimination. In AvgPool, the averages of the values from the set of pluralities of local activation outputs within each component were selected. In all cases, the selected values were passed to the global neural network portion.

As shown in the charts 502, 504, the embodiment of the federated machine learning system performed far better than the other techniques. The favorable comparison to RandomPool is particularly noteworthy, illustrating the superiority of the component-wise ordering and random slice selection technique as shown and described herein.

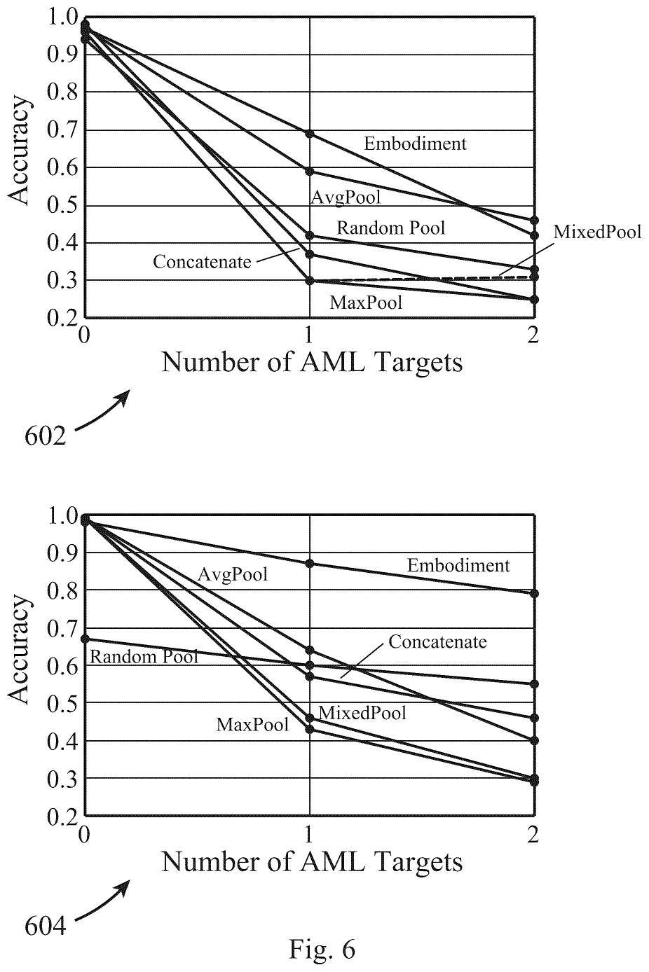

FIG. 6 depicts charts 602, 604 comparing an embodiment to various other techniques in terms of accuracy of adversarial data injection location classification. The charts 602, 604 depict mean accuracy of identifying locations of an adversarial data injection attack on a vertical federated machine learning system deployed to protect a simulated electrical system. The charts 602, 604 depict mean accuracy as a function of number of local neural networks targeted. Chart 602 represents an electrical system with three local geographic regions (and three respective local neural network portions). Chart 604 represents an electrical system with thirteen local geographic regions (and thirteen respective local neural network portions). As in FIG. 5, both electrical systems were simulated using standard IEEE 3-bus and 13-bus Power Energy & Society (PES) test feeder systems. The embodiment and compared techniques were as described herein in reference to FIG. 5.

As shown in the charts 602, 604, the embodiment performed far better than the other techniques. In particular, the embodiment again compared favorably to RandomPool, illustrating the superiority of the component-wise ordering and random slice selection technique as shown and described herein.

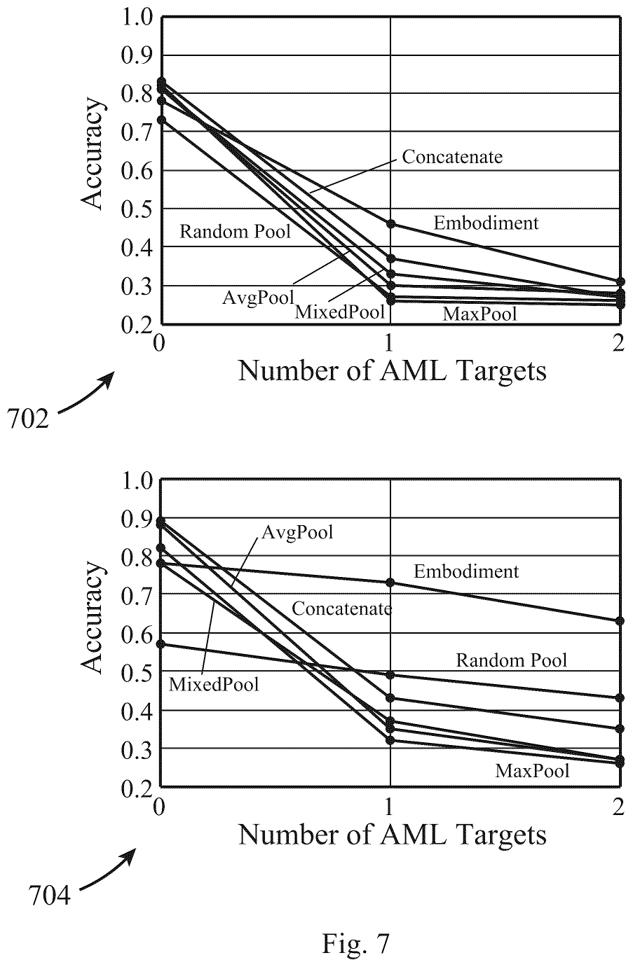

FIG. 7 depicts charts 702, 704 comparing an embodiment to various other techniques in terms of accuracy of adversarial data injection attack type classification. The charts 702, 704 depict mean accuracy of attack type classification for an adversarial data injection attack has occurred on a vertical federated machine learning system deployed to protect a simulated electrical system. The charts 702, 704 depict mean accuracy as a function of number of local neural networks targeted. Chart 702 represents an electrical system with three local geographic regions (and three respective local neural network portions). Chart 704 represents an electrical system with thirteen local geographic regions (and thirteen respective local neural network portions). As in FIGS. 5 and 6, both electrical systems were simulated using standard IEEE 3-bus and 13-bus Power Energy & Society (PES) test feeder systems. The embodiment and compared techniques were as described herein in reference to FIG. 5.

As shown in the charts 702, 704, the embodiment performed far better than the other techniques. Once again, the embodiment compared favorably to RandomPool, further illustrating the superiority of the component-wise ordering and random slice selection technique as shown and described herein.

Note that although embodiments are disclosed herein in reference to protecting an overall energy system, embodiments are not so limited. For example, embodiments may be deployed to protect reinforcement learning controllers for the power system. Embodiments can make such controllers less vulnerable to data injection attacks, which makes the output of the controller better and more consistent. That results in the inverters receiving more accurate power and reactive power control. The voltage and frequency oscillations thereby decrease, thus increasing power grid stability. Consequently, the cost of energy correspondingly decreases with more precise power system control, because less energy is wasted, and there is lower risk of trips and faults.

Note that although embodiments are disclosed herein in reference to detecting adversarial threats in energy systems, embodiments are not so limited. In general, embodiments may be used to detect adversarial threats in any distributed system. For example, embodiments are model-agnostic and can work with any data driven vertical federated machine learning system that includes local portions and a global portion.

Certain examples can be performed using a computer program or set of programs. The computer programs can exist in a variety of forms both active and inactive. For example, the computer programs can exist as software program(s) comprised of program instructions in source code, object code, executable code or other formats; firmware program(s), or hardware description language (HDL) files. Any of the above can be embodied on a transitory or non-transitory computer-readable medium, which include storage devices and signals, in compressed or uncompressed form. Exemplary computer-readable storage devices include conventional computer system RAM (random access memory), ROM (read-only memory), EPROM (erasable, programmable ROM), EEPROM (electrically erasable, programmable ROM), flash memory, and magnetic or optical disks or tapes.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented using computer-readable program instructions that are executed by an electronic processor.

These computer-readable program instructions may be provided to a processor of a general-purpose computer, special purpose computer, or other programmable data processing apparatus to produce a machine, such that the instructions, which execute via the electronic processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

In embodiments, the computer-readable program instructions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer-readable program instructions may execute entirely on a user's computer, partly on the user's computer, as a stand-alone software package, partly on the user's computer and partly on a remote computer or entirely on the remote computer or server.

As used herein, the terms “A or B” and “A and/or B” are intended to encompass A, B, or {A and B}. Further, the terms “A, B, or C” and “A, B, and/or C” are intended to encompass single items, pairs of items, or all items, that is, all of: A, B, C, {A and B}, {A and C}, {B and C}, and {A and B and C}. The term “or” as used herein means “and/or.”

As used herein, language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

While the invention has been described with reference to the exemplary examples thereof, those skilled in the art will be able to make various modifications to the described examples without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A method of identifying an adversarial threat to a utility system using a federated machine learning system, wherein the utility system covers a plurality of local geographic regions, wherein each local geographic region comprises a respective plurality of local utility system data sources, wherein the federated machine learning system comprises: a global neural network portion, and a respective local neural network portion for each of the respective plurality of local utility system data sources, the method comprising:
providing respective local data comprising respective local utility system data from a respective local plurality of utility system data sources to a respective local neural network portion, from which a respective plurality of local activation outputs are obtained;
passing, from respective local neural network portions and to a global database, respective pluralities of local activation outputs, whereby the global database stores a set of pluralities of local activation outputs;
drawing representative local activation outputs from the set of pluralities of local activation outputs, from which a representation of the set of pluralities of local activation outputs is obtained;
passing the representation of the set of pluralities of local activation outputs to the global neural network portion, from which an adversarial threat prediction is obtained; and
outputting an indication of the adversarial threat prediction.

2. The method of claim 1, further comprising ameliorating an adversarial threat specified by the indication of the adversarial threat prediction.

3. The method of claim 1, wherein the adversarial threat comprises an attack using least one of: a false data injection attack, a replay attack, or a denial of service attack.

4. The method of claim 1, wherein the drawing representative local activation outputs from the set of pluralities of local activation outputs comprises selecting, randomly, a slice of local activation outputs from the set of pluralities of local activation outputs.

5. The method of claim 4, further comprising:
prior to the selecting, component-wise ordering local activation outputs in the set of pluralities of local activation outputs, from which a component-wise ordered set of local activation outputs is obtained, wherein the selecting comprises selecting the slice of activation outputs from the component-wise ordered set of local activation outputs.

6. The method of claim 1, further comprising training the federated machine learning system by repeatedly performing actions comprising:
passing respective local training data comprising respective training local utility system data to a respective local neural network portion, from which a respective training plurality of local activation outputs are obtained;
passing, from respective local neural network portions and to the global database, respective training pluralities of local activation outputs, whereby the global database stores a training set of pluralities of local activation outputs;
drawing training representative local activation outputs from the training set of pluralities of local activation outputs, from which a training representation of the set of pluralities of local activation outputs is obtained;
passing the training representation of the set of pluralities of local activation outputs to the global neural network portion, from which a respective loss is obtained; and
back-propagating the respective loss through the federated machine learning system.

7. The method of claim 1, wherein local utility system data is correlated between the plurality of local geographic regions.

8. The method of claim 1, wherein a number of components in the local utility system data varies among the plurality of local geographic regions.

9. The method of claim 8, wherein each plurality of local activation outputs has a same number of components.

10. The method of claim 1, wherein the adversarial threat prediction comprises at least one of: a presence or absence of an adversarial threat, a location of an adversarial threat, or a classification of an adversarial threat.

11. The method of claim 1,
wherein the utility system comprises an energy system,
wherein the energy system covers the plurality of local geographic regions by supplying electricity to each of the plurality of local geographic regions,
wherein a respective plurality of local utility system data sources comprises a respective plurality of local energy system data sources,
wherein the federated machine learning system comprises a respective local neural network portion for each of the respective plurality of local energy system data sources, and
wherein the providing comprises providing respective local data comprising respective local energy system data from a respective local plurality of energy system data sources to a respective local neural network portion.

12. The method of claim 11, wherein the respective local energy system data from the respective local plurality of energy system data sources comprises at least one of: grid information, Supervisory Control and Data Acquisition (SCADA) data, phasor measurement units (PMUs), smart meter information, or load forecast information.

13. The method of claim 11, wherein the adversarial threat comprises an attack on at least one of: power grid measurement signals, power grid control signals, or federated machine learning system communication channels.

14. The method of claim 11, wherein each respective local plurality of energy system data sources comprises at least one cyber system data source and at least one energy system operation data source.

15. The method of claim 11, wherein the energy system operation data source comprises a phasor data source.

16. A non-transitory computer-readable medium comprising instructions that, when executed by an electronic processor, configure the electronic processor to identify an adversarial threat in a utility system using a federated machine learning system by performing actions as recited in claim 1.

17. A system for identifying an adversarial threat in a utility system using federated machine learning, the system for identifying the adversarial threat comprising an electronic processor and a non-transitory computer-readable medium comprising instructions that, when executed by the electronic processor, configure the electronic processor to perform actions as recited in claim 1.
